(19) United States
(12) Patent Application Publication
(10) Pub. No.: US 2004/0249886 A1
(43) Pub. Date: Dec. 9, 2004

(54) Method and device for establishing a connection between a first and a second subscriber in a telecommunications network

(75) Inventor: Robert Kindermann, Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/661,766

(22) Filed: Sep. 15, 2003

(30) Foreign Application Priority Data
Mar. 11, 2002 (EP) 020 05 509.1

(51) Int. Cl. G06F 15/16

(52) U.S. Cl. 709/204; 709/227

(57) ABSTRACT

A method and a device for establishing a connection between a first and a second subscriber in a telecommunications network is specified, in which the address of the second subscriber or an identification assigned to them with which the address can be determined is contained in an attribute of an object OBJ intended for use on a computer PC. With the aid of a function F the address or identification is read out from the attribute and the connection is subsequently established automatically.

The invention relates to a method for establishing a connection between a first and a second subscriber of a telecommunications network,

where an object intended for use on a computer is created,

where an address assigned to the second subscriber in the telecommunications network is inserted into this object,

where this object is transferred to the first subscriber and stored there on a computer,

where, with the aid of a function which is activated by the first subscriber, the address assigned to the second subscriber in the telecommunications network is read out from the object and

where the connection between first and second subscriber is established with the aid of this address.

The invention further relates to a device for executing the method.

Daily life, not only in business but also in the private sphere, is governed more and more as regards the communication media by the transfer of electronic documents. Typical examples are e-mails which can contain practically any type of attached document, as well as the process of uploading and downloading of files familiar from the Internet. This involves the transfer of text documents, images, music, videos, programs and such like. The vast amount of conceivable possibilities makes it impossible even to give an approximate list here. The list given above can thus not be taken as a restriction. The general term “object” is thus used in this document in place of more precise specifications.

The central problem with this type of data traffic is to create a simple option for contacting the author of an object or for getting into contact with a person capable of providing information relating to this object. For this purpose contact addresses are included in the object, something that can be done directly with text documents for example, as part of the transferred text. As well as purely textual information automated contact options are also created however.

A device is known from JP(A) 11017734, “Electronic mail device”, dated Jan. 22, 1999 which allows a telephone connection to be established automatically between the recipient and the sender of an e-mail. To this end said device includes means for receiving the telephone number of the sender and a control which sets up the telephone connection.

A further example are what are known as links, with the aid of which an interested party can automatically be directed on an Internet page to a contact. The automatic creation of an e-mail also represents this type of option. Also known is the setting up of a voice connection with the aid of special links which point to a private branch exchange or to a function which controls the exchange.

An example of such a method is disclosed in U.S. Pat. No. 5,838,682, “Method and apparatus for establishing communications with a remote node on a switched network based on hypertext dialing information received from a packet network”, dated Nov. 17, 1998. This specifies an Internet access system which automatically sets up a connection to a contact via a circuit-switched telecommunications network on request, while the connection to the Internet is in place via a packet-switched network. To this end links are inserted into an HTML file which, when activated, establish a preprogrammed telephone connection. A further example is WO-A-0186897, “System for enabling one-click telephone connections”, dated Nov. 15, 2001 from which it is known that an e-mail recipient can automatically establish a voice connection with the sender of this e-mail. To this end the telephone number of the sender is stored in a database, a corresponding link inserted into the e-mail and, on activation of this link, a voice connection between these parties is established with the aid of the recipient's telephone number. Finally U.S. Pat. No. 5,991,394, “Method and system for establishing voice communications using a computer network”, dated Jan. 23, 1999 discloses a system which gives the user the opportunity to request a call back on an Internet page from a contact associated with this page. This involves specifying the telephone number of the user via a second page and subsequently establishing a voice connection.

A further form of specifying a contact option is to use attributes which are appended to the object. These are not contained in the object in the true sense but are rather appended to it, even if the object as a rule can only be transferred as a whole, that is with attributes. For the requirements of the present invention an object thus at least consists of actual content and of a number of attributes. Attributes which can be provided for example are the name of a contact, their physical address or e-mail address as well as further information such as date of storage, file size or similar. Attributes are stored in such cases in a “Header area” of an object for example.

In accordance with the prior art there is no option of establishing an automated connection to a contact without changing the content of the object. As a rule therefore an address of a subscriber transferred in a telecommunications network must be entered manually.

The object of the invention is thus to specify a method which makes it possible to establish a connection in a simple manner between a first and a second subscriber in a telecommunications network.

This is done in accordance with the invention using a method of the type stated at the start of this document, in which the address assigned to the second subscriber in the telecommunications network is added as an attribute to the content of the object and is read out from there.

The advantage of this is the automated setup of a connection between a first and a second subscriber of a telecommunications network, where the second subscriber is generally the author of an object a person capable of providing information relating to this object. In this case the address assigned to the second subscriber in the telecommunications network is inserted as an attribute in an object, by the author himself for example. This object is then transferred to the first subscriber, for example by e-mail, via data media or also by means of a download from an Internet page and is stored transiently or permanently there. For the purposes of establishing contact with the second subscriber, the first subscriber then activates a function which reads out the address assigned to the second subscriber from the attribute and establishes the desired connection. As a rule this will be a real time communications connection, such as a voice connection or a multimedia connection, but it is also of course conceivable to send text messages, for example with the aid of the Short Message Service, SMS. Real time communication in this case is not just restricted to circuit switched telecommunications networks, but naturally also extends to packet-switched telecommunications networks.

It is pointed out in this connection that in this context laptops, palmtops and similar devices with which objects can be processed, can also be regarded as computers.

The object of the invention is further achieved by a method,

where an object is created for use on a computer,

where an identification assigned to the second subscriber is inserted into this object,

where this object is transferred to the first subscriber and stored there on a computer,

where, with the aid of a function which is activated by the first subscriber, the address assigned to the second subscriber in the telecommunications network is determined using the identification contained in the object

where the connection between first and second subscriber is established with the aid of this address and

where the identification assigned to the second subscriber is used as an attribute at a content of the object and is read out from there.

The major difference between this solution and the one already described is the insertion here of the identification of the second subscriber into the attribute of the object, for example their name, if necessary including further information such as their address. With the aid of this identification a function is used to determine the actual address of the second subscriber in the telecommunications network. A means for assigning address to identification is a table which is accessed by the function. In the simplest case the table comprises two columns, one for of the name of the subscriber for example and one for the address assigned to this subscriber in the telecommunications network. As a storage location for this table it is conceivable on the one hand to use any computer on which the function to establish the connection is also activated, but on the other hand to also use any other storage location to which this computer has access, such as in a telephone directory administered centrally in a computer network or a data medium. If the identification is structured in the appropriate way it is also conceivable to determine an address by means of an algorithm. For example a first part of the address can be determined with the aid of the first attribute, a second part of the address with a second attribute.

it is also advantageous

if the identification contained in the attribute of the object can be transferred in the telecommunications network using the function activated by the first subscriber,

if the address of the second subscriber is determined there on the basis of this identification and

if the connection is established to the second subscriber.

With this variant of the invention the address/identification of the second subscriber is assigned in the telecommunications network itself. In this case the identification is transferred into the telecommunications network with the aid of the function activated by the first subscriber and is evaluated there, or subsequently the connection is also established. This is especially advantageous when the required data and is provided centrally by a telecommunications network operator or if a private branch exchange within a company is involved.

A variant of the invention is also advantageous.

in which an e-mail is provided as the object,

in which an e-mail address of the second subscriber is included as the identification and

in which the address of the second subscriber in the telecommunications network is determined on the basis of this e-mail address.

In this case an identification of the second subscriber which its present in any event is advantageously included to determine their address in the telecommunications network. Thus not only can contact be established with the sender of a message by answering this message but also the method in accordance with invention is applied. The same method of transfer used to receive the message is thus not included for answering but another method, namely the method in accordance with invention. This is especially advantageous if it seems to make less sense to answer an e-mail than to make a telephone call to the sender.

the object of the invention is further achieved with a computer which is provided for executing the method in accordance with invention,

where this includes means for establishing a connection between a first and a second subscriber on the basis of an address assigned to the second subscriber,

where this includes a function for reading out the address assigned to the second subscriber from an object of this computer and

where the address assigned to the second subscriber is inserted as an attribute to a content of the object.

A device is specified with which the automated setup of a connection between a first and a second subscriber of a telecommunications network becomes possible, where the second subscriber is generally the author of an object or a person capable of providing information relating to this object. In this case the attribute of an object includes the address assigned to the second subscriber in the telecommunications network. This serves for example as an entry parameter of a modem integrated into the computer.

It is pointed out that the advantages specified for the method also apply in equal measure to the device as well as to devices used in the same way as a computer such as laptops, palmtops and such like, as well as mobile telephones where these are suitable for administering objects.

The object of the invention is finally achieved with a computer which is provided for executing the method in accordance with invention.

where this includes means for establishing a connection between a first and a second subscriber on the basis of an address assigned to the second subscriber,

where this includes a function for reading out an identification assigned to the second subscriber from an object of this computer and

where this includes a function for transferring the address assigned to the second subscriber on the basis of this identification and

where the address assigned to the second subscriber is inserted as an attribute to a content of the object.

The major difference from the solution already explained is that here it is not the address of the second subscriber themselves which is included in the attribute of the object but an identification assigned to it. In this case the computer also includes a function for reading out the identification from the attribute as well as a further function for assigning an address of the second subscriber in the telecommunications network to this identification. The splitting of the two separate functions is not a mandatory requirement here. Instead the two tasks can also be performed by one and the same function.

the invention is explained in more detail on the basis of an exemplary embodiment shown in the Figures which relate to the establishment of a connection between a first and its second subscriber in a telecommunications network with the aid of the objects and functions in accordance with the invention.

The diagrams show:

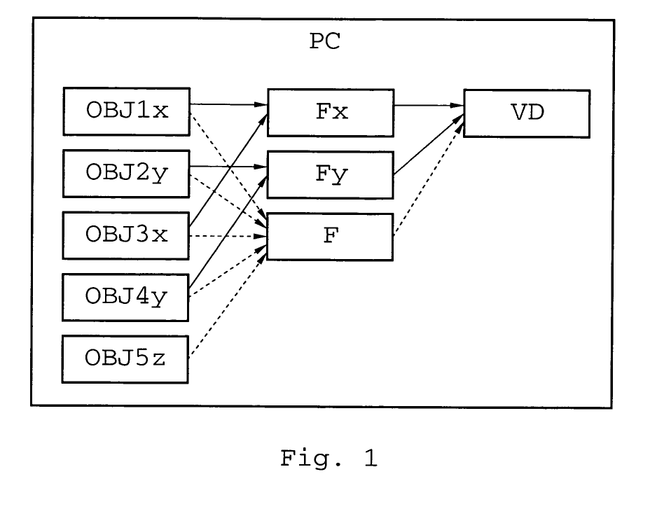

FIG. 1: A computer PC in which various objects in accordance with invention OBJ and functions F are administered;

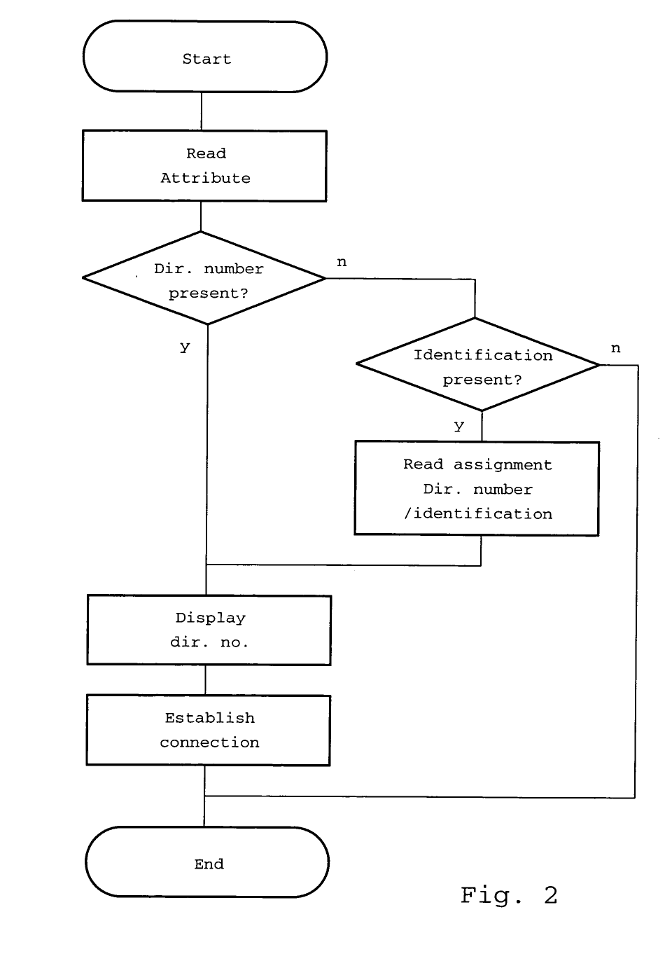

FIG. 2: A flowchart of typical function F in accordance with the invention for setting up a connection;

FIG. 1 shows a Computer PC, in which various objects in accordance with the invention OBJ and functions F are administered. These are a first object of type x OBJ1x, a second object of type y OBJ2y, a third object of type x OBJ3x, a fourth object of type y OBJ4y and a fifth object of type z OBJ5z. In addition a first function Fx, a second function Fy and a third function F, as well as a switching service VD are administered in the computer PC.

The arrangement shown in FIG. 1 functions as follows:

All objects of type x, in this specific case the first object OBJ1x and the third object OBJ3x, can be processed with the aid of the first function Fx, but objects of other types cannot. This state is indicated by arrows drawn with solid lines. For example the first function Fx can be available within a Word processing program. The content of the object of type x consists of texts in this case. In addition the objects include attributes suitable for setting up a connection.

All objects of type y, in this specific case the second object OBJ2y and the fourth object OBJ4y, can be processed with the aid of the second function Fy, but the other types cannot This state is indicated by arrows drawn with solid lines. For example graphical data formats can be provided for objects of type y.

Finally a third function F is administered in the computer PC which is suitable for processing all three types available. As a rule processing will be restricted in this case to those procedural steps required to set up a connection in a telecommunications network. The objects OBJ which are suitable as input for the third function F are indicated by arrows drawn with dashed lines in the Figure.. in this specific case the method in accordance with the invention can be applied to the fifth object OBJ5z only with the aid of the third function F. This is the case for example if a program provided for processing objects of type z does not include the function in accordance with the invention. In order to make the method in accordance with the invention available to the computer PC user despite this, a separate program created for this purpose can be provided.

All three functions F forward the request to establish a connection to the switching service VD which handles central tasks independent of the different types. This can include the control of a modem for example.

FIG. 2 shows a flowchart of a typical function F in accordance with the invention for setting up a connection.

The flowchart shown in FIG. 2 functions as follows:

The execution sequence of the function F initiated by the first subscriber starts with the Start state. To start with the attributes contained in the object are read out. Then a check is made as to whether they contain a directory number for a subscriber of a telecommunications network. If they do, the number is displayed to the first subscriber and subsequently the connection to the second subscriber is set up. The function then changes to the End state.

If no directory number can be read out, a check is made as to whether an identification assigned to the second subscriber is included as an attribute. If it is, then the directory number assigned to the second subscriber is determined on the basis of this identification. Subsequently the directory number is again displayed, the connection to the second subscriber established and a change made to the End state.

If however a directory number is not included as an attribute nor is there an identification with which the directory number of the second subscriber can be determined, the execution sequence of the function branches directly to the End state.

1. Method for establishing a connection between a first and a second subscriber of a telecommunications network,
where an object OBJ intended for use on a computer PC is created,
where an address assigned to the second subscriber in the telecommunications network is inserted into this object OBJ
where this object OBJ is transferred to the first subscriber and stored there on a computer PC,
where, with the aid of a function F which is activated by the first subscriber, the address assigned to the second subscriber in the telecommunications network is read out from the object OBJ and
where the connection between first and second subscriber is established with the aid of this address, in that,
the address assigned to the second subscriber in the telecommunications network is added as an attribute to the content of the object OBJ and is read out from there.

2. Method for establishing a connection between a first and a second subscriber of a telecommunications network,
where an object OBJ intended for use on a computer PC is created,
where an identification assigned to the second subscriber is inserted into this object OBJ,
where this object OBJ is transferred to the first subscriber and stored there on a computer PC,
where, with the aid of a function F which is activated by the first subscriber, the address assigned to the second subscriber in the telecommunications network is determined using the identification contained in the object OBJ and
where the connection between first and second subscriber is established with the aid of this address, in that,
the identification assigned to the second subscriber is added as an attribute to a content of the object OBJ and is read out from there.

3. Method in accordance with claim 2, characterized in that,
the identification contained in the attribute of the object OBJ is transferred in the telecommunications network using the function F activated by the first subscriber,
the address of the second subscriber is determined there on the basis of this identification and
the connection to the second subscriber is established.

4. Method in accordance with one of the claims 1 to 3, characterized in that
an e-mail is provided as object OBJ
an e-mail address of the second subscriber is included as identification and
the address of the second subscriber in the telecommunications network is determined on the basis of this e-mail address.

5. Computer PC which is provided for execution of a method in accordance with one of the claims 1 to 4,
where this includes means for establishing a connection between a first and a second subscriber on the basis of an address assigned to the second subscriber and
where this includes a function for reading out from an object OBJ of this computer PC the address assigned to the second subscriber,
the address assigned to the second subscriber is added as an attribute to a content of the object OBJ.

6. Computer PC which is provided for execution of a method in accordance with one of the claims 1 to 4,
where this includes means for establishing a connection between a first and a second subscriber on the basis of an address assigned to the second subscriber,
where this includes a function F for reading out an identification assigned to the second subscriber from an object OBJ of this computer PC and
where this includes a function F for transferring the address assigned to the second subscriber on the basis of this identification
characterized in that,
the address assigned to the second subscriber is added as an attribute to a content of the object OBJ.
